(19) United States
(12) Patent Application Publication
(10) Pub. No.: US 2024/0007954 A1
(43) Pub. Date: Jan. 4, 2024

(54) Power Control Apparatus and a Power Control Method for a Mobile Device

(71) Applicants: Robert Bosch GmbH, Stuttgart (DE); Bosch Global Software Technologies Private Limited, Bangalore (IN)

(72) Inventors: Arnab Ashes Sanyal, Thane (IN); Deshpande Pranav Shadanan, Bengaluru (IN); Pullaratt Abdulla Shameem, Kozhikode (IN); Thunoli Payyanvalappil Dibisha, Kannur (IN)

(21) Appl. No.: 18/345,937

(22) Filed: Jun. 30, 2023

(30) Foreign Application Priority Data
Jun. 30, 2022 (IN) 2022 4103 7881

(51) Int. Cl. H04W 52/02; G01P 15/18

(52) U.S. Cl. CPC H04W 52/0254; G01P 15/18

(57) ABSTRACT

A power control apparatus includes an acceleration sensor and a controller. The acceleration sensor measures vibration generated due to movement of a mobile device and outputs a vibration measurement signal. The controller is configured to detect an insertion condition of the mobile device inside a storage compartment based on the vibration measurement signal. The controller varies a power state of the mobile device upon detecting the insertion condition of the mobile device inside the storage compartment. The controller detects the insertion condition of the mobile device inside the storage compartment using a machine learning model.

This application claims priority under 35 U.S.C. § 119 to patent application no. IN 2022 4103 7881, filed on Jun. 30, 2022 in India, the disclosure of which is incorporated herein by reference in its entirety.

The disclosure relates to an apparatus and a method for controlling power state of a mobile device such as laptop, mobile phone, etc.

### BACKGROUND

Power consumption is an important challenge in using the mobile electronic devices such as laptop, mobile phone, etc. Different strategies are being used by the corporations to optimize the power efficiency of the mobile electronic devices.

United Stated published patent application no. US2021/255686 discloses a method and system for managing power states transitions of a portable electronic device. A gesture recognition module recursively checks the variation between ‘flat’ and ‘not flat’ states. The module calculates the mean value of acceleration along the 3 axes to detect if the device is in a flat state. This attempts to understand the angle that the base of the laptop is making with the surface it is being kept on

### SUMMARY

The disclosure describes a power control apparatus for a mobile device. The power control apparatus comprises an acceleration sensor and a controller. The acceleration sensor measures vibration generated due to movement of the mobile device and outputs a vibration measurement signal. The controller is configured to detect insertion condition of the mobile device inside a storage compartment based on the vibration measurement signal. The controller varies a power state of the mobile device upon detecting the insertion condition of the mobile device inside the storage compartment. Examples of the mobile device, includes but not limited to, a laptop computer, a palmtop computer, a mobile phone, a personal electronic device, and a personal digital assistant. The controller employs a Machine Learning (ML) model built using vibration measurement signals generated due to different movements and different positions of the mobile device, while inserting the mobile device inside the storage compartment.

The controller detects the insertion condition of the mobile device inside the storage compartment using the ML model. The controller varies the power state of the mobile device to a very low power state upon detecting the insertion condition of the mobile device inside the storage compartment. Examples of the storage compartment, include but not limited to, a bag, a briefcase, a suitcase, a pocket, a cabinet, and a pouch.

The disclosure describes a method for controlling a power state of a mobile device. The method involves measuring vibration generated due to movement of the mobile device by an acceleration sensor and outputting a vibration measurement signal. Insertion condition of the mobile device inside a storage compartment is detected by a controller based on the vibration measurement signal. Power state of the mobile device is varied by the controller upon detecting the insertion condition of the mobile device inside the storage compartment.

The insertion condition of the mobile device in the storage compartment is detected using a Machine Learning (ML) model. The ML model is built using vibration measurement signal generated due to different movements and positions of the mobile device, while inserting the mobile device inside the storage compartment. The power state of the mobile device is changed to a very low power state upon detecting the insertion condition of the mobile device inside the storage compartment.

### BRIEF DESCRIPTION OF THE DRAWINGS

An embodiment of the disclosure is described with reference to the following accompanying drawing.

FIG. 1 shows a schematic block diagram of a power control apparatus for a mobile device, according to an embodiment of the disclosure.

FIGS. 2A, 2B, 2C, and 2D show schematic views illustrating insertion condition of a mobile device in a storage compartment, according to an embodiment of the disclosure.

FIGS. 3A, 3B, and 3C show different graphs illustrating vibration measurement signals generated during different kinds of insertions of a mobile device in a bag, according to an embodiment of the disclosure.

FIG. 4 shows a flow chart of a power control method for a mobile device, according to an embodiment of the disclosure.

### DETAILED DESCRIPTION

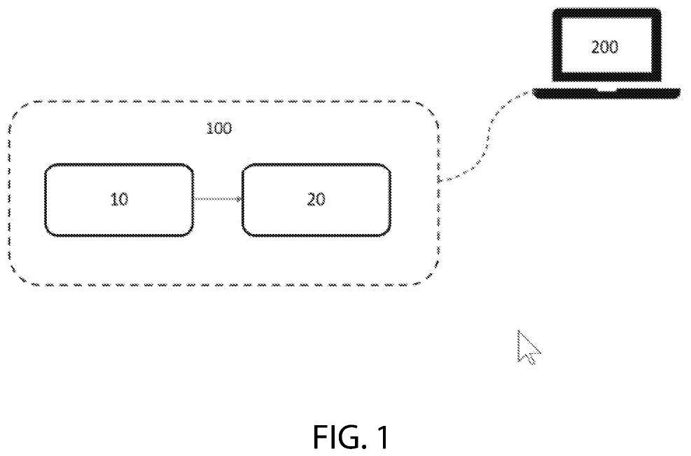

FIG. 1 shows a schematic block diagram of a power control apparatus for a mobile device, according to an embodiment of the disclosure. The power control apparatus 100 comprises an acceleration sensor 10 and a controller 20. The power control apparatus 100 can be part of the mobile device 200 such as a laptop, a palmtop, a Personal Digital Assistant (PDA), a mobile phone, any personal electronic device etc. The power control apparatus 100 may be in the form of a chip which can be suitably mounted to the mother board of the mobile device 200. Examples of the acceleration sensor 10, can include, but not limited to, different kinds of acceleration sensors such as piezoelectric, piezo-resist, capacitive or MEMS type acceleration sensors, etc. The acceleration sensor 10 may be an integral part the mobile device 100 itself.

The acceleration sensor 10 measures vibration generated due to movement of the mobile device 200 and outputs a vibration measurement signal. The vibration measurement signal may be generated along the 3 axes. In an embodiment of the invention, existing acceleration sensor 10 inside the mobile device 200 measures the vibration and outputs a vibration measurement signal.

The controller 20 receives and analyzes the vibration measurement signal, based on which the controller 20 detects insertion condition of the mobile device 200 inside a storage compartment. Examples of the storage compartment 50, include but not limited to, a bag, a briefcase, a suitcase, a pocket, a cabinet, and a pouch.

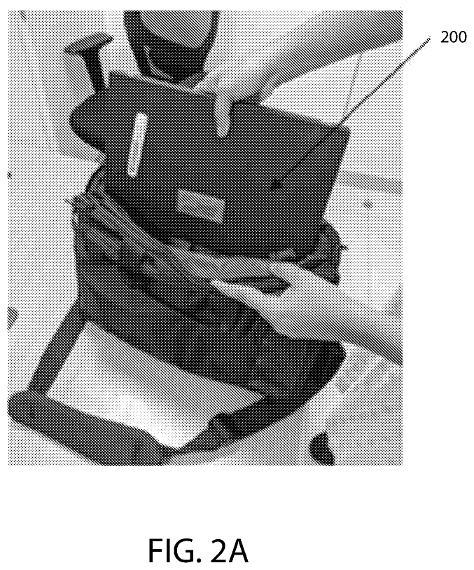

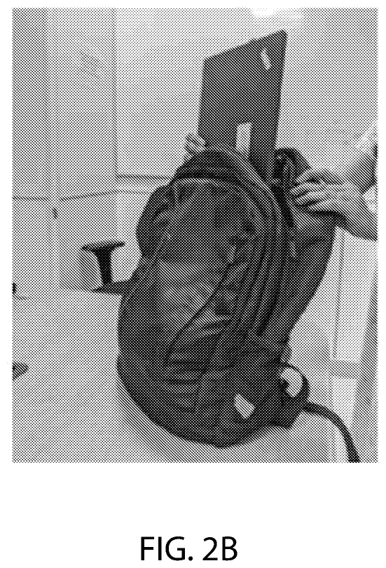

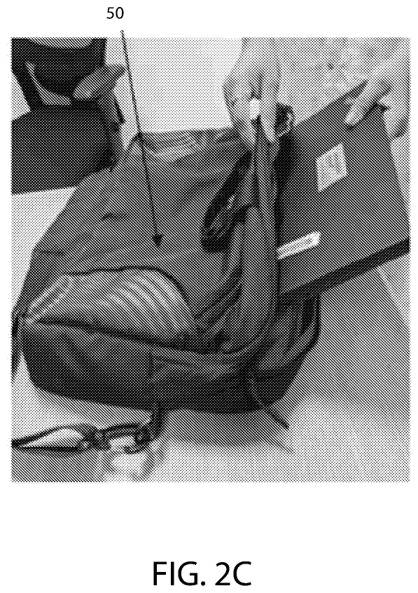

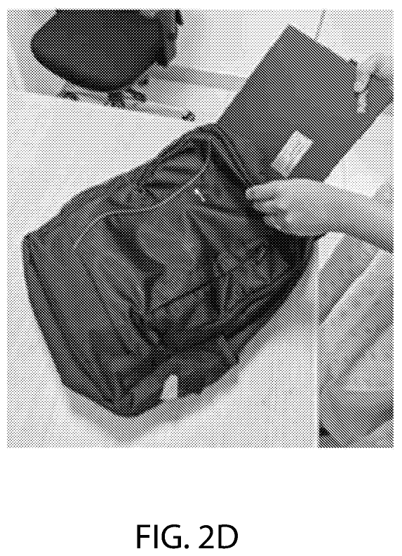

FIGS. 2A, 2B, 2C, and 2D show schematic views illustrating insertion condition of a mobile device in a storage compartment, according to an embodiment of the disclosure. FIGS. 2A and 2B depict a scenario of inserting a laptop into a bag, when bag is kept vertically on table. FIG. 2C depicts insertion of a laptop into a bag, where bag is kept horizontally on table. FIG. 2D depicts insertion of a laptop into a bag where the bag is kept 45 degrees inclined on a table.

The controller 20 varies a power state of the mobile device 200 upon detecting the insertion condition of the mobile device 200 inside the storage compartment 50. The controller 20 employs an Artificial Intelligent (AI) model which is built using vibration measurement signals generated due to different movements and different positions of the mobile device 200, while inserting the mobile device 200 inside the storage compartment 50.

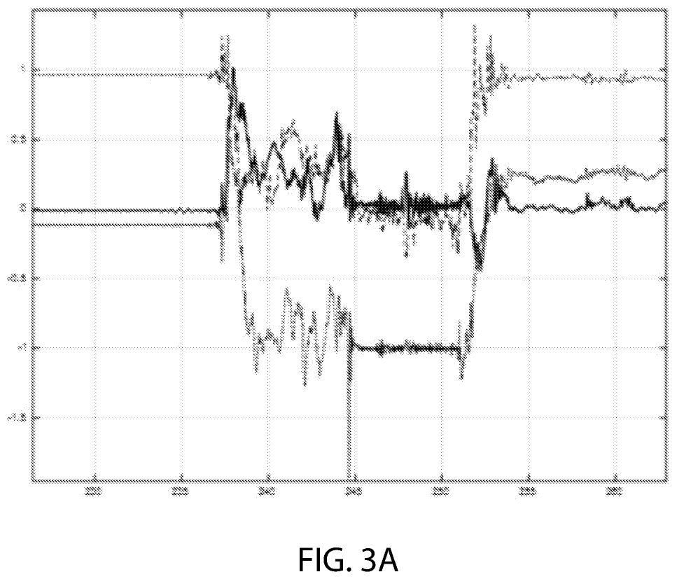

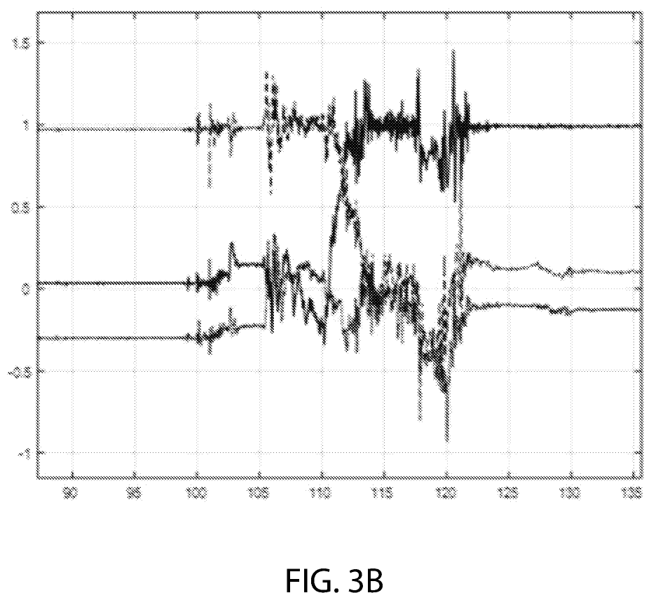

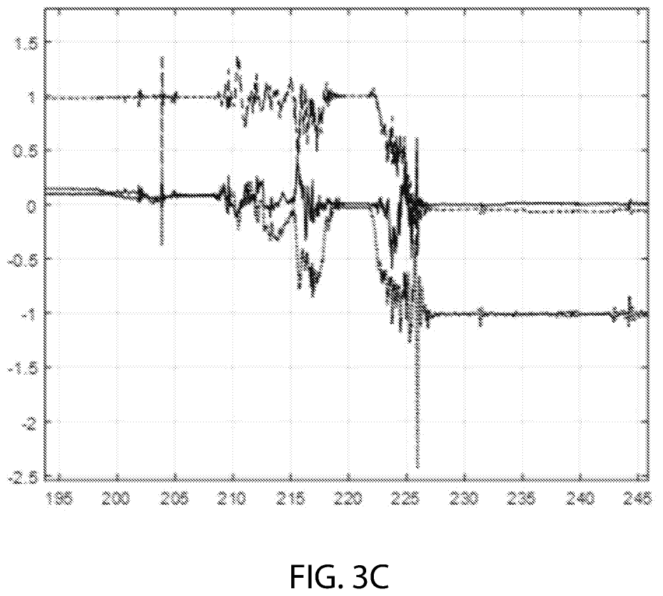

FIGS. 3A, 3B, and 3C show different graphs illustrating feature values of vibration measurement signals indicating different kinds of insertions of a mobile device in a bag, according to an embodiment of the disclosure. More specifically, FIG. 3A depicts a graph showing vibration measurement signals generated during a scenario of inserting a laptop into a bag, when bag is kept vertically on table. FIG. 3B depicts a graph showing vibration measurement signals generated during insertion of a laptop into a bag, where bag is kept horizontally on table. FIG. 3B depicts a graph showing vibration measurement signals generated during insertion of a laptop into a bag where the bag is kept 45 degree inclined on a table. It is to be noted that these figures show only few examples, which may not be construed in a limiting manner. There are various possible steps and positions possible while inserting the mobile device 200 inside the storage compartment 50 and the corresponding vibration measurement signals are captured and used for building the ML model. The ML model can be a Deep Learning (DL) model.

Various such vibration measurement signals with feature values generated during different positions, and postures while inserting the mobile device 200 inside a storage compartment 50 are captured, analyzed and used to build the ML model. The controller 20 detects the insertion condition of the mobile device 200 inside the storage compartment 50 using the ML model. The controller 20 varies the power state of the mobile device 200 to a very low power state upon detecting the insertion condition of the mobile device 200 inside the storage compartment 50. For instance, the controller 20 may close the applications opened in the mobile device 200, turn off the WiFi, switch to low brightness mode or even switch off the mobile device 200. The controller 20 waits for a threshold period after detecting the insertion condition of the mobile device 200 into the storage compartment 50, before switching to a low power state. This avoids frequent switching of power states and thereby improves power conservation and user's convenience.

Since different types of insertion of mobile device inside a storage compartment can be detected precisely, automatic switching to low power mode during non-use time can be achieved, thereby power saving is improved.

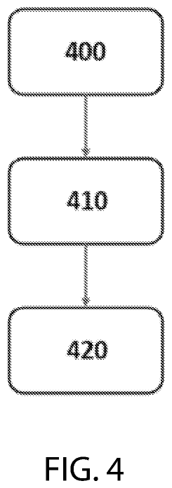

FIG. 4 shows a flow chart of a power control method for a mobile device, according to an embodiment of the disclosure. The method involves measuring vibration generated due to movement of the mobile device 200 by an acceleration sensor 10 and outputting a vibration measurement signal at step 400. The acceleration sensor 10 may be a part of the mobile device 200 itself.

At step 410, insertion condition of the mobile device 200 inside a storage compartment is detected by a controller 20 based on the vibration measurement signal. When there is a transition in the mobile device 200, it is recognized by the controller based on the signal from the acceleration sensor 10. Upon analyzing the vibration measurement signal, the controller 20 checks if the mobile device 200 is being inserted in a storage compartment 50. At step 420, power state of the mobile device 200 is varied by the controller 20 upon detecting the insertion condition of the mobile device inside the storage compartment 50.

The insertion condition of the mobile device 200 in the storage compartment 50 is detected using a Machine Learning (ML) model. The ML model is built using vibration measurement signal generated due to different movements and positions of the mobile device 200, while inserting the mobile device 200 inside the storage compartment 50. The power state of the mobile device 50 is changed to a very low power state upon detecting the insertion condition of the mobile device 200 inside the storage compartment 50. The controller 20 waits for a threshold period after detecting the insertion condition of the mobile device 200 into the storage compartment 50, before switching to a low power state. This is done to avoid hasty decision and wrong switching of power state

The disclosure does not use any extra sensors like light sensor to detect the insertion of the mobile device into the storage compartment or bag. Thereby cost is reduced. Further, various ways of keeping the mobile device in the storage compartment is analyzed and used for building the ML model. Hence accuracy of the detecting the insertion condition of the mobile device in the storage compartment is improved.

It must be understood that the embodiments explained in the above detailed description are only illustrative and do not limit the scope of this invention. Any modification to the vandalism detection system using microphone and camera having artificial intelligence model and the method thereof are envisaged and form a part of this invention. The scope of this invention is limited only by the claims.

What is claimed is:

1. A power control apparatus for a mobile device, comprising:
an acceleration sensor configured to measure vibration generated due to movement of the mobile device and to output a vibration measurement signal; and
a controller configured (i) to detect an insertion condition of the mobile device inside a storage compartment based on the vibration measurement signal, and (ii) to vary a power state of the mobile device based on the detected insertion condition of the mobile device inside the storage compartment.

2. The power control apparatus as claimed in claim 1, wherein the mobile device is one of a laptop computer, a palmtop computer, a mobile phone, a personal electronic device, and a personal digital assistant.

3. The power control apparatus as claimed in claim 1, wherein the controller uses a machine learning model built using vibration measurement signals generated due to different movements and different positions of the mobile device while inserting the mobile device inside the storage compartment.

4. The power control apparatus as claimed in claim 3, wherein the controller is configured to detect the insertion condition of the mobile device inside the storage compartment using the machine learning model.

5. The power control apparatus as claimed in claim 3, wherein the controller is configured to detect the insertion condition of the mobile device inside the storage compartment by analyzing and propagating the vibration measurement signals through the machine learning model.

6. The power control apparatus as claimed in claim 3, wherein the controller analyzes the vibration measurement signal for a specific period to confirm the insertion condition of the mobile device inside the storage compartment.

7. The power control apparatus as claimed in claim 1, wherein the storage compartment is one of a bag, a brief case, a suit case, a pocket, a cabinet, and a pouch.

8. The power control apparatus as claimed in claim 1, wherein the controller is configured to vary the power state of the mobile device to a very low power state based on the detected insertion condition of the mobile device inside the storage compartment.

9. A method for controlling a power state of a mobile device, the mobile device comprising an acceleration sensor and a controller, the method comprising:
measuring vibration generated due to movement of the mobile device using the acceleration sensor and outputting a vibration measurement signal;
detecting an insertion condition of the mobile device inside a storage compartment based on the vibration measurement signal using the controller; and
varying a power state of the mobile device using the controller based on the detected insertion condition of the mobile device inside the storage compartment.

10. The method as claimed in claim 9, further comprising:
detecting the insertion condition of the mobile device in the storage compartment using a machine learning model.

11. The method as claimed in claim 10, wherein the machine learning model is built using vibration measurement signals generated due to different movements and positions of the mobile device, while inserting the mobile device inside the storage compartment.

12. The method as claimed in claim 9, further comprising:
confirming the insertion condition of the mobile device inside the storage compartment after analyzing the vibration measurement signal for a specific period.

13. The method as claimed in claim 9, further comprising:
changing the power state of the mobile device to a very low power state based on the detected insertion condition of the mobile device inside the storage compartment.

14. A method of training a machine learning model for controlling a power state of a mobile device, the method comprising:
receiving vibration measurement signals generated corresponding to different positions and postures of the mobile device during insertion of the mobile device into a storage compartment; and
collecting and analyzing the received vibration measurement signals to precisely determine various possible steps and positions of the mobile device while inserting the mobile device inside the storage compartment in real-time.

15. The method according to claim 14, wherein the vibration measurement signals include at least (i) vibration measurement signals generated during insertion of the mobile device in the storage compartment kept horizontally on a table, (ii) vibration measurement signals generated during insertion of the mobile device in the storage compartment kept vertically on the table, and (iii) vibration measurement signals generated during insertion of the mobile device in the storage compartment kept at different inclinations degrees on the table.

16. The method according to claim 14, wherein a computer program comprises instructions which, when the computer program is executed by a computer, cause the computer to carry out the method.

17. The method according to claim 14, wherein a non-transitory computer-readable medium comprises instructions which, when executed by a computer, cause the computer to carry out the method.
